(19) United States
(12) Patent Application Publication
(10) Pub. No.: US 2003/0154130 A1
(43) Pub. Date: Aug. 14, 2003

(54) Method and apparatus for targeted point of purchase promotion

(76) Inventors: Douglas C. Woolley, Toronto (CA); John C. Duff, Burlington (CA)

Correspondence Address: Mark B. Eisen, c/o Dimock Stratton Clarizio LLP, 20 Queen Street West, Suite 3202, Box 102, Toronto, ON, M5H 3R3, CA

(21) Appl. No.: 10/347,940

(22) Filed: Jan. 22, 2003

(30) Foreign Application Priority Data
Feb. 11, 2002 (CA) 2,371,411

(51) Int. Cl. G06F 17/60

(52) U.S. Cl. 705/14; 725/78

(57) ABSTRACT

A method and apparatus for providing a video promotional message relating to a specific product at the location of the retail outlet where such product is displayed. A video monitor is disposed in the field of vision of a product type and displays a recurring video promotion. The video monitors each preferably include a wireless receiver adapted to receive a signal containing at least one video promotion transmitted directly to the monitor, or from a server and/or other local distribution equipment preferably located in a non public area of the store. The promotional messages are preferably distributed to the monitors, written into a memory and repeatedly played in a recurring fashion.

### FIELD OF THE INVENTION

This invention relates to promotion. In particular, this invention relates to a method and apparatus for targeted point of purchase promotional messaging in a retail environment.

### BACKGROUND OF THE INVENTION

Retailers are constantly struggling to find effective methods for promoting merchandise at the point of purchase. Flyers, public address announcements and strategically placed signage are examples of existing point of purchase promotion methods. These promotional methods attempt to take advantage of the fact that in most product areas, the bulk of purchase decisions are made at the point of purchase, and more specifically, at the point of viewing the merchandise or “point of decision.” However, the proliferation of such promotional messaging techniques has resulted in consumers being inundated, and thus unconsciously ignoring most of these types of promotions, essentially as a type of “background noise”.

Particular problems are associated with the promotion of products which are manufactured by or for a retailer and sold under the retailer's proprietary trademark or “house brand.” Typically such products provide the retailer with a much higher profit margin than “national brand” merchandise. However, national brand merchandise has the advantage of many other promotional outlets, which may include wide-scale television advertising, newspaper and magazine advertising, etc., which raises consumer awareness and credibility of the national brand product to a level far greater than that of the house brand product.

Furthermore, through many years of conditioning, some consumers have come to perceive house brand products in general as being inferior to their national brand counterparts, even though this is often untrue, and in fact many house brand products are of superior quality relative to their national brand counterparts. Accordingly, even where there is a significant price differential between the house brand and the national brand product, consumers will often purchase the national brand product at a much higher cost, based on the belief that it is of superior quality, unaware that the higher price is primarily due to higher national brand marketing costs. Unfortunately for the retailer, because retail stores must be organized in a manner which allows customers to find the products that they are looking for, house brand merchandise is usually necessarily shelved alongside national brand merchandise, giving the customer the choice of either product at the point of purchase, which is usually where the purchase decision is made.

The retailer has the benefit of having within their premises pre-qualified consumers specifically looking for certain types of products and ready to make a purchase. It would accordingly be advantageous to provide the retailer with a system and method for targeting consumer promotions based on the specific products being sought by specific consumers, and offering a promotional message which would both dispel misconceptions regarding differences in quality between house brand and national brand merchandise and allow the retailer an opportunity to promote the product which it is to the retailer's advantage to promote—whether it be a house brand product or a competing national brand product—right at the point of decision.

### SUMMARY OF THE INVENTION

The present invention accomplishes this by providing a method and apparatus for targeted point of purchase promotion, which promotes specific products to only those consumers who are exhibiting an interest in such products. Further, the method and apparatus of the invention provides a stimulating, eye-catching and highly credible means of promoting such products right at the point of purchase, in a manner which provides a greater likelihood of diverting the consumers attention from a particular product (for example a national brand product) to a product which is more to the retailer's advantage to sell (for example, a house brand product or a different national brand product), to thus increase the retailers profitability.

The invention accomplishes this by providing a video promotional message relating to a specific product, at the specific location of the retail outlet where such product is shelved. A video monitor is disposed in the field of vision of a product type, for example affixed to the shelf at the particular point where a national brand product meets a house brand product of that product type. The video monitor displays a recurring video promotion specifically addressing the particular product or products. The video promotion targets consumers who are already looking for that product type, and have thus shown a specific interest in that product type, because the video display monitor is positioned so that it is visible to a customer viewing the shelved product. The video promotional message provides a highly credible and eye-catching means of promoting the product, and particularly for extolling the benefits of one brand of product over another brand of product of that product type.

In the preferred embodiment a plurality of video monitors are respectively promoting different product types within the retail environment, each of which displays a video promotional message relating to the specific product type in its immediate vicinity. Power supply outlets are usually provided throughout a retail store, and the monitors thus have a readily available power source. In order to avoid having to run video cable throughout the store, the video monitors each preferably include a wireless receiver adapted to receive a signal containing the video promotion, either directly, or from a local transmitter which receives a signal, for example over a global communications network such as the Internet, over telephone lines, via satellite or through some other means, the local transmitter optionally including a server for storing and disseminating video promotional messages.

If a local transmitter is used, with or without a server, it is preferably located in a non public area of the store. The video promotional messages relating to the different product types are distributed to each video monitor selectively, for example by utilizing different wireless frequencies for different monitors, or using packet switching techniques through which each monitor receives all signals but processes only those packets intended for the destination monitor. Thus, a plurality of video promotional messages are distributed about the retail premises, while each video monitor displays only the video promotional message or messages relating to the product type in the immediate vicinity of that particular monitor.

The signals containing the promotional messages are preferably distributed to the monitors, at which point they are decoded if necessary and written into a memory, and read from the memory by circuitry which repeatedly plays the message in a looping or recurring fashion. Each message can thus be easily altered, merely by distributing a new promotional message signal to one or more particular monitors, to overwrite the previous promotional message, for example with a new message, when the product brand or type on the adjacent shelf is changed, or a new product is added.

The video promotion can be installed, operated and maintained by an entity separate from the retail store, for example through a promotion administration server 60 connected to the Internet as shown in FIG. 4. The retailer could thus direct such entity as to what the content of the promotional messages should be and the distribution thereof about the retail premises, but the retailer would not have to be involved in the actual creation or distribution of the promotional messages.

These and other advantages of the invention will be apparent from the description which follows.

The present invention thus provides a method of promoting a product in a retail store, comprising the steps of a. disposing a video monitor in a field of vision of the product; b. transmitting at least one video promotion relating to the product to a receiver associated with the monitor; and c. displaying the video promotion on the monitor in a recurring fashion.

In further aspects of the method of the invention: the method comprises after step b. the step of: storing the video promotion at the monitor; the product type is represented by at least one national brand product and at least one house brand product; the product type is represented by at least two national brand products; the method comprises the step of distributing the video promotion to a plurality of monitors via wireless communications; the video promotions are distributed via local distribution equipment located in the retail store; the video promotions are received by the distribution equipment via a global communications network; the distribution equipment comprises a server storing the video promotions; the monitors are affixed to shelves upon which the product is displayed; and/or the video monitor comprises an erasible memory for storing the video promotion.

The present invention further provides an apparatus for promoting a product in a retail store, comprising a video monitor for mounting in a field of vision of the product, comprising or connected to a receiver; a distributor for transmitting at least one video promotion relating to the product to the receiver; and circuitry for displaying the video promotion on the monitor in a recurring fashion.

In further aspects of the apparatus of the invention: the monitor comprises or is connected to a video storage device for storing the promotional message; the video promotion is distributed to a plurality of monitors via wireless communications; the distributor comprises a server for storing the video promotions; the video promotions are received by the distributor via a global communications network; the monitors are affixed to shelves upon which the product is displayed; and/or the video storage device comprises an erasable memory.

### DESCRIPTION OF THE DRAWINGS

In drawings which illustrate by way of example only a preferred embodiment of the invention,

FIG. 1 is a schematic view of an apparatus according to the invention in which the monitors receive transmissions from a source external to the retail store,

FIG. 2 is an elevation of a video monitor for displaying a promotional message at the point of purchase,

FIG. 3 is a schematic view of an apparatus according to the invention in which the monitors receive transmissions from a local server and transmitter, and

FIG. 4 is a schematic view of a system of the invention in which the promotions are managed by a third party over the Internet.

### DETAILED DESCRIPTION OF THE INVENTION

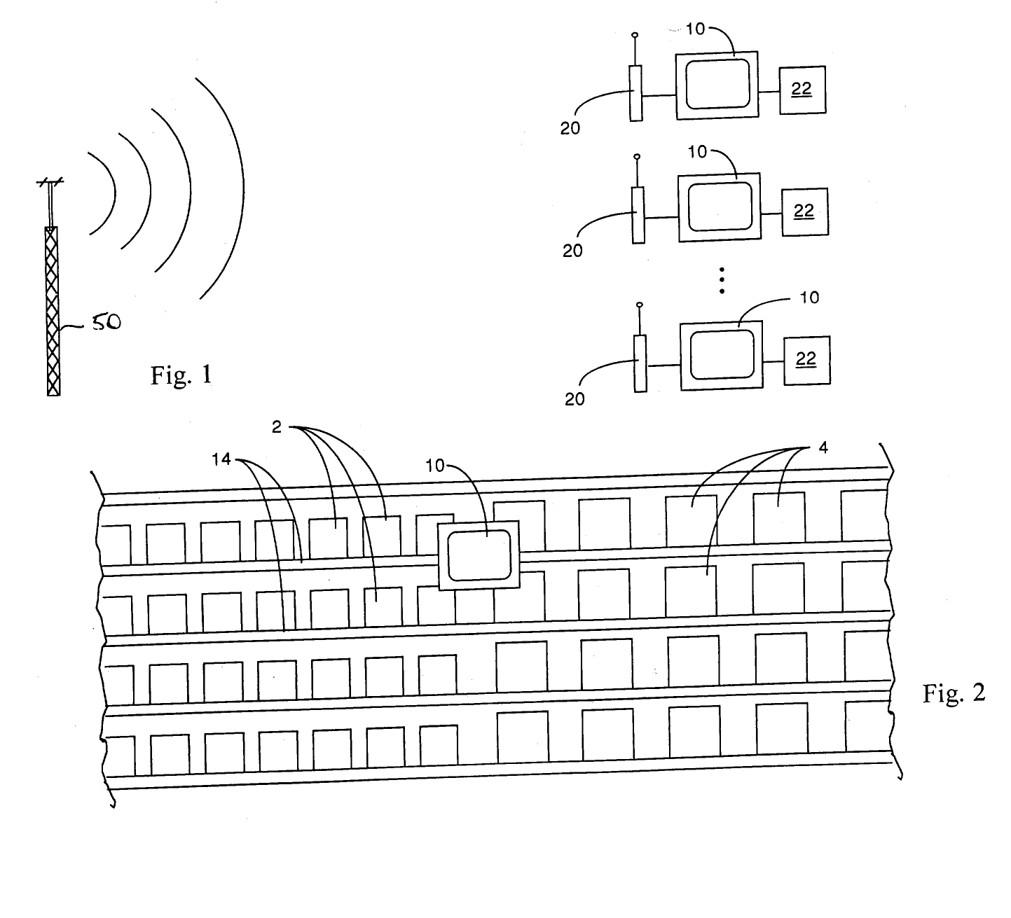

Referring to FIGS. 1 and 2, a plurality of video monitors 10, each adapted to display a promotional message relating to a specific product or product type, is mounted in the field of vision of the product, for example affixed by brackets to a merchandise display shelf 14 displaying one or more brands of products 2, 4 of that product type. Advantageously the monitor 10 may be mounted at the particular point where a national brand product 2 meets a house brand product 4 of that product type, or where competing national brand products 2, 4 meet on the store shelf 14. Preferably the monitor 10 is mounted so as not to obstruct shelf space.

The video monitor 10 is adapted to display a recurring video promotion addressing either a single product or one or more competing products 2, 4, optionally addressing competing products 2, 4 in a comparative fashion. The video monitor 10 is positioned so that it is within the field of vision of the products 2, 4, i.e. visible to a customer viewing the shelved products 2, 4. Typically one video monitor 10 is provided for a set of competing products 2, 4 which the retailer wishes to distinguish by the promotional message or messages, so in the preferred embodiment a plurality of video monitors are respectively disposed in the vicinity of different product types within the retail store. Each monitor 10 displays a video promotional message relating to the product type in its immediate vicinity.

Each monitor 10 is suitably powered, for example it may be powered by a battery or other portable power source (not shown), which may optionally be rechargeable, but to minimize maintenance requirements each monitor 10 is preferably connected to a mains power supply outlet (not shown) in the vicinity of the monitor 10. The video monitors 10 each preferably each include, or are connected to, a wireless receiver 20, preferably built into the monitor 10 but optionally a separate wireless receiver 20, adapted to receive a signal containing the video promotion. This avoids the need to run video cable throughout the store, but it is also possible to implement the invention in a wired configuration. Each monitor 10 further includes, or is connected to, a memory 22, for example a RAM having sufficient storage capacity to receive and store the video promotional messages. The monitor 10 is designed to read from the RAM 20 repetitively, to thus play the video message in a recurring or looping fashion.

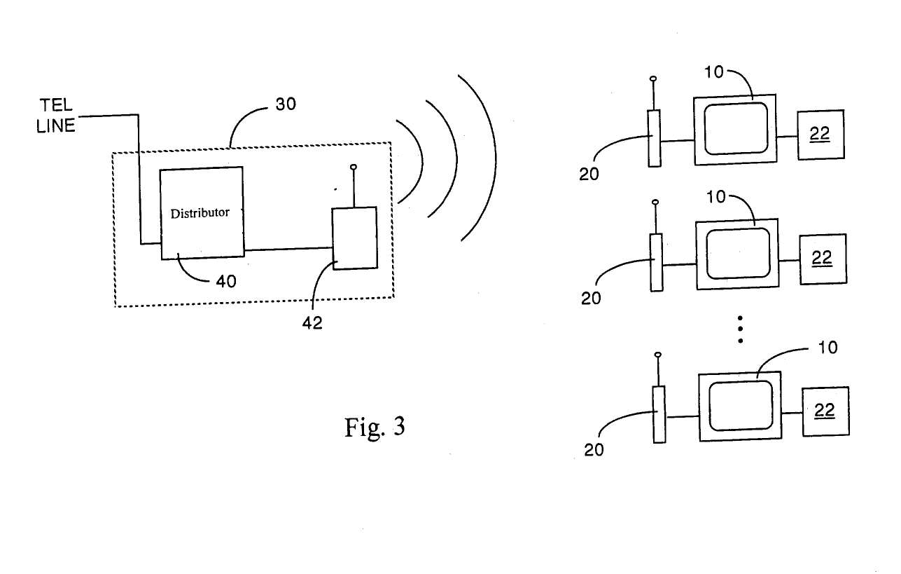

The promotional messages may be transmitted to the respective video monitors 10 directly from a source 50 external to the retail premises, for example an external transmitter as shown in FIG. 1. Alternatively, as shown in FIG. 3, promotional messages may be transmitted to the respective video monitors 10 by a local server, hub, router or other suitable distributor 40 via built-in or external transmitter 42, which has the capability of both storing and distributing promotional video messages, or via any other suitable distributing equipment 30 which receives a signal from an external source and distributes the signal about the retail premises. Where a server 40 is used the signal may be provided by any external source, for example via the Internet, over telephone lines as shown in FIG. 3, via satellite, any other rf or microwave source, or through any other means of transmitting a signal to the video monitors 10.

If local distributing equipment 30 is used, it is preferably located in a non public area of the store, for example a back room or office. The video promotional messages relating to the different product types are distributed to each video monitor 10 selectively, for example by utilizing different wireless frequencies for the receivers 20 associated with different monitors 10, or by packet switching techniques through which each monitor 10 receives all signals but processes only packets intended for one or more particular destination monitor(s) 10. Thus, a plurality of video promotional messages can be distributed simultaneously, successively, in bursts etc. about the retail premises, while each video monitor 10 displays, and preferably stores, only video promotional messages intended for that particular monitor 10.

In operation, prepared video promotional messages are converted to the desired signal format, and transmitted directly to the video monitors 10 from an external source or transmitted to local distribution equipment 30. The signals containing the promotional messages, which may be encoded and in any suitable format, are broadcast throughout the retail store and received by all receivers 20 tuned to the broadcast frequency, and if packet switching is used, stored for display by each monitor 10 recognizing packetized information as being addressed to the destination monitor. The receivers 20 decode the signal if necessary and write the signal into memory 22. Thereafter the looping circuitry in the monitor 10 repeatedly plays the promotional message. Messages can be managed remotely, for example by a third party service provider, and any message can be altered merely by distributing a new promotional message signal to one or more particular monitors 10, to overwrite the previous promotional message stored in memory 22.

A customer in the vicinity of a particular product type views the promotional message, which for example may suitably advertise one or more adjacent products 2, 4 on the store shelf 14, and the promotional message thus has a much greater chance of influencing the customer's purchase decision, being viewed by the customer not only at the precise point of purchase but also at the precise time the purchase decision needs to be made.

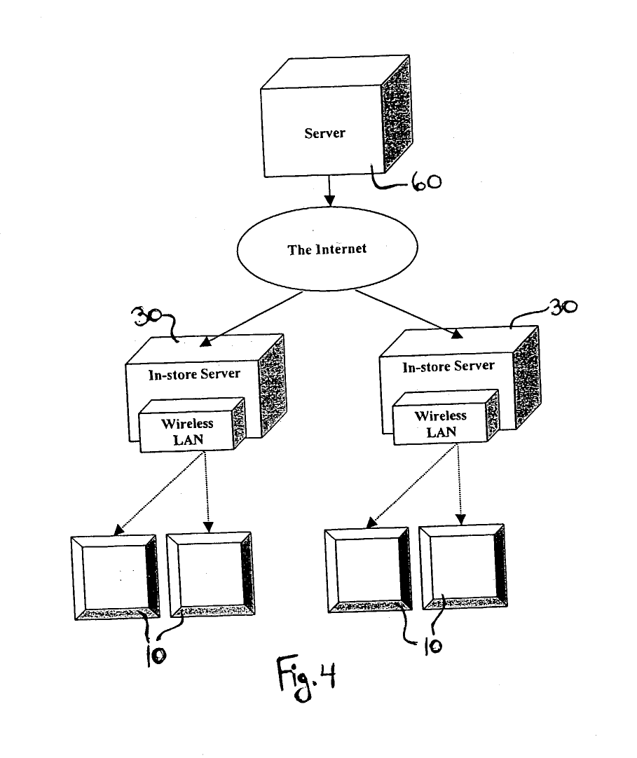

The video promotional system of the invention can be leased, installed, operated and maintained by an entity separate from the retailer, for example a third party promotions administrator responsible for the actual creation and/or distribution of the promotional messages via server 60, as shown in FIG. 4. The retailer retains control over the content of the promotional messages, and the distribution of messages about the retail premises based on where the retailer chooses to display the different product types.

It is also possible to store all video messages in a central server which forms part of the distribution equipment 30, and distribute the messages to the various destination monitors 10 as described above, in real time. This would be an acceptable alternative in a wired distribution system, however, even with presently available compression techniques it is expected that the resolution and/or frame rate of the video message would have to be sacrificed in order to effect this method in a wireless distribution system. Moreover, it is unnecessary to repeatedly transmit the promotional message to the monitor 10, when a single transmission will suffice to store the message in the monitor 10 from which it can be replayed in a recurring fashion without taxing the server's capacity.

Various embodiments of the present invention having been thus described in detail by way of example, it will be apparent to those skilled in the art that variations and modifications may be made without departing from the invention. The invention includes all such variations and modifications as fall within the scope of the appended claims.

We claim:

1. A method of promoting a product in a retail store, comprising the steps of
a. disposing a video monitor in a field of vision of the product;
b. transmitting at least one video promotion relating to the product to a receiver associated with the monitor; and
c. displaying the video promotion on the monitor in a recurring fashion.

2. The method of claim 1 comprising after step b. the step of: storing the video promotion at the monitor.

3. The method of claim 1 wherein the product type is represented by at least one national brand product and at least one house brand product.

4. The method of claim 1 wherein the product type is represented by at least two national brand products.

5. The method of claim 1 comprising the step of distributing the video promotion to a plurality of monitors via wireless communications.

6. The method of claim 5 wherein the video promotions are distributed via local distribution equipment located in the retail store.

7. The method of claim 6 wherein the video promotions are received by the distribution equipment via a global communications network.

8. The method of claim 6 wherein the distribution equipment comprises a server storing the video promotions.

9. The method of claim 1 wherein the monitors are affixed to shelves upon which the product is displayed.

10. The method of claim 1 wherein the video monitor comprises an erasable memory for storing the video promotion.

11. An apparatus for promoting a product in a retail store, comprising
a video monitor for mounting in a field of vision of the product, comprising or connected to a receiver;
a distributor for transmitting at least one video promotion relating to the product to the receiver; and
circuitry for displaying the video promotion on the monitor in a recurring fashion.

12. The apparatus of claim 11 wherein the monitor comprises or is connected to a video storage device for storing the promotional message.

13. The apparatus of claim 11 wherein the video promotion is distributed to a plurality of monitors via wireless communications.

14. The apparatus of claim 11 wherein the distributor comprises a server for storing the video promotions.

15. The apparatus of claim 14 wherein the video promotions are received by the distributor via a global communications network.

16. The apparatus of claim 11 wherein the monitors are affixed to shelves upon which the product is displayed.

17. The apparatus of claim 11 wherein the video storage device comprises an erasable memory.
